(19) United States
(12) Patent Application Publication
(10) Pub. No.: US 2023/0032411 A1
(43) Pub. Date: Feb. 2, 2023

(54) MANUFACTURING APPARATUS OF CATHODE ACTIVE MATERIAL FOR LITHIUM ION SECONDARY BATTERIES, AND METHOD OF MANUFACTURING CATHODE ACTIVE MATERIAL FOR LITHIUM ION SECONDARY BATTERIES

(71) Applicant: TOYOTA JIDOSHA KABUSHIKI KAISHA, Toyota-shi (JP)

(72) Inventor: Tomohiro YOKOYAMA, Toyota-shi (JP)

(73) Assignee: TOYOTA JIDOSHA KABUSHIKI KAISHA, Toyota-shi (JP)

(21) Appl. No.: 17/830,576

(22) Filed: Jun. 2, 2022

(30) Foreign Application Priority Data
Aug. 2, 2021 (JP) 2021-126618

(51) Int. Cl. H01M 4/04

(52) U.S. Cl. CPC H01M 4/0471; H01M 4/0435; H01M 2004/028

(57) ABSTRACT

Provided is a manufacturing apparatus of a cathode active material for lithium ion secondary batteries that enables productivity to improve. The manufacturing apparatus of a cathode active material for lithium ion secondary batteries includes: a conveying device conveying a cathode active material raw material that contains a metallic compound and a lithium compound, the metallic compound including at least one metallic element selected from the group consisting of nickel, cobalt and manganese; and a heating unit adapted to heat the cathode active material raw material, wherein the heating unit has at least one heating member adapted to heat the cathode active material raw material by heat conduction.

### FIELD

The present application relates to a manufacturing apparatus of a cathode active material for lithium ion secondary batteries, and a method of manufacturing a cathode active material for lithium ion secondary batteries.

### BACKGROUND

Lithium ion secondary batteries are widely used as power sources for, for example, laptop computers and portable terminal, and for driving vehicles. Therefore, it is demanded to improve the productivity of lithium ion secondary batteries, and of cathode active materials to be used for lithium ion secondary batteries.

A general method of manufacturing a cathode active material for lithium ion secondary batteries is as follows. First, cathode active material raw material is obtained by mixing a metal hydroxide including nickel or the like, and a lithium compound (such as lithium hydroxide and lithium carbonate) which are to be a precursor. Next, the cathode active material raw material is oxidized by calcination thereof. Specifically, the metal hydroxide is oxidized to a metal oxide, and the lithium compound is oxidized to lithium oxide. Subsequently, a predetermined sagger is filled with the calcined cathode active material raw material, and the raw material is fired. A lithium metal oxide that is the cathode active material is obtained by the reaction between the metal oxide and lithium oxide in the cathode active material raw material, which is caused by the firing. The obtained cathode active material is recovered and utilized for lithium ion secondary batteries. For example, Patent Literatures 1 to 3 disclose such a method of manufacturing a cathode active material.

A firing device such as a rotary kiln is used in the step of calcining the cathode active material raw material. A rotary kiln is a device that enables a cathode active material raw material to be stirred and heated at the same time in an oxidizing atmosphere, and enables the oxidation of the cathode active material raw material to be promoted. The reason why the cathode active material raw material is calcined is to prevent the temperature irregularity in the cathode active material raw material due to the oxidation reaction between the metal hydroxide and the lithium compound, which is an endothermic reaction, from occurring.

A firing device such as a roller hearth kiln is used in the step of firing the cathode active material raw material. The roller hearth kiln enables the cathode active material raw material to be heated at a higher temperature than in the firing step, and enables the cathode active material to be manufactured by the reaction between the metal oxide and lithium oxide in the cathode active material raw material. Pressure may be applied for densifying the cathode active material raw material when the sagger is filled with the cathode active material raw material. The densification of the cathode active material raw material allows the contact area between the metal oxide and lithium oxide in the cathode active material raw material to increase, and the firing to be promoted.

### CITATION LIST

### Patent Literature

Patent Literature 1: JP 2020-113429 A
Patent Literature 2: JP 2019-175694 A
Patent Literature 3: JP 2020-198195 A

### SUMMARY

### Technical Problem

A rotary kiln is a device for oxidizing metal hydroxides and/or lithium compounds. Thus, it is necessary to actively feed air or oxygen into a rotary kiln, and make the inside of the rotary kiln an oxidizing atmosphere. Such necessity to actively feed air or oxygen into a rotary kiln results in higher production costs.

A roller hearth kiln is a device for firing the calcined cathode active material raw material. It is necessary to fill a sagger with the cathode active material raw material for uniform heating. However, temperature irregularity easily occurs in the cathode active material raw material according to the way of the hot air flow in the device. Short-term heating in a condition where temperature irregularity occurs in the cathode active material raw material results in variations in the crystallinity of the manufactured cathode active material. Therefore, it is necessary to heat the cathode active material raw material for a long time in order to suppress temperature irregularity when the cathode active material is manufactured with a roller hearth kiln. This however results in an increase in production costs. The necessity of long-term heating also requires larger-scale facilities often.

An object of the present application is to provide a manufacturing apparatus of a cathode active material for lithium ion secondary batteries and a method of manufacturing a cathode active material for lithium ion secondary batteries which enables productivity to improve.

### Solution to Problem

As one means for solving the above problems, the present disclosure is provided with a manufacturing apparatus of a cathode active material for lithium ion secondary batteries, the apparatus comprising: a conveying device conveying a cathode active material raw material that contains a metallic compound and a lithium compound, the metallic compound including at least one metallic element selected from the group consisting of nickel, cobalt and manganese; and a heating unit adapted to heat the cathode active material raw material, wherein the heating unit has at least one heating member adapted to heat the cathode active material raw material by heat conduction.

In the manufacturing apparatus, the heating member may be a heating roller. The heating members may be plural heating rollers, some of the heating rollers adapted to heat one surface of the cathode active material raw material, and a rest of the heating rollers adapted to heat another surface of the cathode active material raw material may be alternately arranged from an upstream side to a downstream side in a conveying direction, and any adjacent two of the heating rollers may be arranged as facing each other so as to hold the cathode active material raw material therebetween. Further, a wrap angle of the heating roller(s) may be 10° to 180°.

In the manufacturing apparatus, in the heating unit, the cathode active material raw material may be heated to 700° C. to 1000° C. In the heating unit, the cathode active material raw material may be heated in an oxidizing atmosphere.

In the manufacturing apparatus, the conveying device may have a conveying member made of a porous heat-resistant member, and the cathode active material raw material may be heated with the heating member via the porous heat-resistant member.

The manufacturing apparatus may further comprise: a forming member adapted to form the cathode active material raw material into a sheet, the forming member being on the upstream side of the heating unit in the conveying direction. The manufacturing apparatus may further comprise: a recovery part adapted to recover a cathode active material obtained in the heating unit.

As one means for solving the above problems, the present disclosure is provided with a method of manufacturing a cathode active material for lithium ion secondary batteries, the method comprising: preparing a cathode active material raw material by mixing a metallic compound and a lithium compound, the metallic compound including at least one metallic element selected from the group consisting of nickel, cobalt and manganese, and obtaining the cathode active material raw material; and heating the cathode active material raw material, wherein in the heating, the cathode active material raw material is heated by heat conduction.

In the method, in the heating, the cathode active material raw material may be conveyed and heated at the same time. In the heating, both surfaces of the cathode active material raw material, and either surface of the cathode active material raw material may be alternately heated. Further, in the heating, the cathode active material raw material may be heated using a heating roller having a wrap angle of 10° to 180°.

In the method, in the heating, the cathode active material raw material may be heated to 700° C. to 1000° C. In the heating, the cathode active material raw material may be heated in an oxidizing atmosphere. Further, in the heating, the cathode active material raw material may be heated via a porous heat-resistant member.

The method may further comprise: forming the cathode active material raw material into a sheet, prior to the heating. The method may further comprise: recovering a cathode active material obtained in the heating.

### Advantageous Effects

A conventionally used roller hearth kiln is to heat air therein, and then to heat a cathode active material raw material. That is, a roller hearth kiln is to heat a cathode active material raw material by convective heating. Convective heating needs long-term firing because temperature irregularity easily occurs in the cathode active material raw material according to the way of the hot air flow in the kiln as described above, which is problematic.

In contrast, contact heating in which the cathode active material raw material is heated by heat conduction is employed in the present disclosure. The features of contact heating are that a contacted portion can be efficiently heated, and that the temperature irregularity in the contacted portion is slight (the thermal uniformity of the contacted portion is high). Therefore, according to the present disclosure, where contact heating is employed, the time for firing the cathode active material raw material can be shortened, and variations in crystallinity can be reduced. In addition, the cathode active material can be obtained by firing the cathode active material raw material with one heating unit (heating step) according to the present disclosure, which is different from a conventional apparatus or method. Therefore, according to the present disclosure, the productivity of the cathode active material can be improved.

### BRIEF DESCRIPTION OF DRAWINGS

FIG. 1 is a schematic view of a manufacturing apparatus of a cathode active material for lithium ion secondary batteries 100;

FIG. 2 explanatorily shows a wrap angle x;

FIG. 3 is an enlarged view of heating rollers 31;

FIG. 4 is a schematic view of a manufacturing apparatus of a cathode active material for lithium ion secondary batteries 200;

FIG. 5 is a flowchart of a method of manufacturing a cathode active material for lithium ion secondary batteries 1000;

FIG. 6 is a flowchart of a method of manufacturing a cathode active material for lithium ion secondary batteries 2000; and

FIG. 7 is a flowchart of a method of manufacturing a cathode active material for lithium ion secondary batteries 3000.

### DESCRIPTION OF EMBODIMENTS

[Manufacturing Apparatus of Cathode Active Material for Lithium Ion Secondary Batteries]

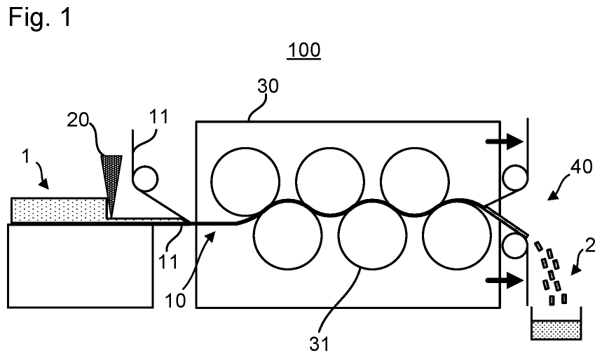

A manufacturing apparatus of a cathode active material for lithium ion secondary batteries according to the present disclosure will be described with reference to a manufacturing apparatus of a cathode active material for lithium ion secondary batteries 100 which is one embodiment (may be referred to as “manufacturing apparatus 100” in this description). FIG. 1 shows a schematic view of the manufacturing apparatus 100. Here, in FIG. 1, the right-left direction is defined as a conveying direction, the up-down direction is defined as a height direction, and the back-front direction is defined as a width direction.

As shown in FIG. 1, the manufacturing apparatus 100 is provided with a conveying device 10, a forming member 20, a heating unit 30 and a recovery part 40. FIG. 1 also shows a cathode active material raw material 1 that is a raw material, and a cathode active material 2 that is a product.

<Cathode Active Material Raw Material 1>

The cathode active material raw material 1 contains a metallic compound and a lithium compound, and may further contain a recycled material such as the cathode active material 2 in a deteriorated and crushed state. The cathode active material raw material 1 can be fired with high thermal uniformity in the heating unit 30 even if containing the deteriorated cathode active material 2.

The cathode active material raw material 1 may be obtained by mixing these materials. The mixing way is not particularly limited, but a known method may be employed therefor. For example, these materials may be mixed with a mortar or a blender.

(Metallic Compound)

The metallic compound includes at least one metallic element selected from the group consisting of nickel, cobalt and manganese. The metallic compound may include nickel, may include nickel and cobalt, or may include nickel, cobalt and manganese. The metallic compound may further include any other metallic element(s). For example, the metallic compound may further include aluminum. The metallic compound may include aluminum instead of manganese.

For example, the molar ratio of the metallic elements of the metallic compound may be as follows. Ni:Co:Mn=x:y:z (x=1−y−z, 0≤y<1 and 0≤z<1) or Ni:Co:Al=x:y:z (x=1−y−z, 0≤y<1 and 0≤z<1).

The metallic compound may be a metal hydroxide, a metal oxide, a metal carbonate or a metal perhydroxide. These metallic compounds may be used alone or in combination. The metallic compound is preferably a metal hydroxide or a metal oxide.

Any known metal hydroxide including at least one metallic element selected from the group consisting of nickel, cobalt and manganese may be used as the metal hydroxide, and examples thereof include NiₓCo_{y}Mn_{z}(OH)_{2+α} (x=1−y−z, 0≤y<1, 0≤z<1 and 0≤α<1) and NiₓCo_{y}Al_{z}(OH)_{2+α} (x=1−y−z, 0≤y<1, 0≤z<1 and 0≤α<1). Any known metal oxide including at least one metallic element selected from the group consisting of nickel, cobalt and manganese may be used as the metal oxide, and examples thereof include NiₓCo_{y}Mn_{z}(O)_{2+α} (x=1−y−z, 0≤y<1, 0≤z<1 and −1≤α<0) and NiₓCo_{y}Al_{z}(O)_{2+α} (x=1−y−z, 0≤y<1, 0≤z<1 and −1≤α<0).

The metallic compound may be prepared by a known method. The following are an example of the method of preparing the metal hydroxide, and an example of the method of preparing the metal oxide. The method of preparing the metallic compound is not limited to them.

An example of the method of preparing the metal hydroxide is crystallization. Hereinafter an example of the method of preparing the metal hydroxide by crystallization will be described.

First, a metal source solution is prepared by dissolving a Ni source, a Co source and a Mn source (or an Al source) in an aqueous solvent (e.g., ion-exchanged water). As the metal source, a metallic salt of each metal element (i.e., a Ni salt, a Co salt and a Mn salt (or an Al salt)) may be used. The type of the metallic salt is not particularly limited, but any known metallic salts such as a hydrochloride, a sulfate, a nitrate, a carbonate and a hydroxide may be used. These metal sources are added to the aqueous solvent in no particular order. One may separately prepare aqueous solutions of the metal sources, and mix them. The ratio of the metal sources is suitably adjusted so that a desired metal hydroxide can be obtained.

Next, the metal source solution and an aqueous solution of NH₃ are dropped into an alkaline aqueous solution in an inert atmosphere while the alkaline aqueous solution is stirred. For example, an aqueous sodium hydroxide may be used as the alkaline aqueous solution. The pH of the alkaline aqueous solution is set in, for example, 11 to 13. The aqueous solution of NH₃ is dropped while the concentration thereof is kept in the range of, for example, 5 g/L to 15 g/L. As the metal source solution and the aqueous solution of NH₃ are dropped into the alkaline aqueous solution, the pH of the resultant solution gradually decreases. Thus, one may additionally drop an alkaline aqueous solution suitably and keep the pH in a predetermined range.

After a certain period of time has passed, the resultant is subjected to vacuum filtration, and the settling is recovered. The metal hydroxide is obtained by washing and drying the obtained settling. The settling may be washed plural times. The settling may be dried by air or by heating. The settling may be dried by heating at, for example, 120 to 180° C.

The metal oxide may be prepared by, for example, subjecting the metal hydroxide to oxidizing roasting. Oxidizing roasting here is to heat the metal hydroxide in an oxidizing atmosphere. The heating temperature is not particularly limited as long as the metal hydroxide can be converted into the metal oxide thereat, but is, for example, 700° C. to 800° C. The heating time is not particularly limited as long as the metal hydroxide can be converted into the metal oxide therefor, but is, for example, 0.5 hours to 3 hours. Such heating may be carried out using a firing device such as a rotary kiln.

The mean particle diameter of the metallic compound is not particularly limited, but is, for example, in the range of 1 μm to 1 mm. In this description, “mean particle diameter” is a median diameter that is a particle diameter at the 50% integrated value in the volume-based particle diameter distribution obtained by the laser diffraction and scattering method.

The content of the metallic compound in the cathode active material raw material is suitably set so that a desired cathode active material can be obtained.

(Lithium Compound)

The lithium compound is not particularly limited as long as being a compound including lithium. A known lithium compound may be used, and examples thereof include lithium oxide, lithium hydroxide, lithium nitrate and lithium carbonate. Lithium hydroxide, lithium nitrate, lithium carbonate, and the like each become lithium oxide by oxidation.

The type of the lithium compound is suitably selected according to the type of the metallic compound because the heating temperature (firing temperature) is changed according to the type of the metallic compound. For example, a case where a metal hydroxide or a metal oxide including nickel, cobalt and manganese is used as the metallic compound needs the firing temperature at approximately 800° C. Therefore, in this case, lithium carbonate is preferably selected as the lithium compound. A case where a metal hydroxide or a metal oxide including nickel, cobalt and aluminum is used as the metallic compound needs the firing temperature at approximately 500° C. Therefore, in this case, lithium hydroxide is preferably selected as the lithium compound.

The content of the lithium compound in the cathode active material raw material is suitably set so that a desired cathode active material can be obtained.

(Shape of Cathode Active Material Raw Material 1)

The shape of the cathode active material raw material 1 is not particularly limited, but may be a sheet. The cathode active material raw material 1 in the form of a sheet is easy to be uniformly heated through. As a result, nonuniform heating is suppressed, and variations in the crystallinity of the cathode active material 2 to be produced are also reduced. The cathode active material raw material 1 in the form of a sheet is also easy to be crushed at the recovery part 40.

The thickness of the cathode active material raw material 1 in the form of a sheet is not particularly limited, but for example, may be at least 0.1 mm, at least 0.5 mm, at least 1 mm, at least 2 mm, at most 50 mm, at most 30 mm, less than 30 mm, at most 20 mm, at most 10 mm, or at most 5 mm. The cathode active material raw material 1 in the form of a sheet having too large a thickness is difficult to be uniformly heated. The cathode active material raw material 1 in the form of a sheet having too small a thickness leads to lower productivity.

The cathode active material raw material 1 may be formed into a sheet with the forming member 20 and/or heating members 31, or may be formed into a sheet by, for example, press molding in advance. One may form the cathode active material raw material 1 into a sheet in advance, and further form the cathode active material raw material 1 with the forming member 20 and/or the heating members 31 so that the cathode active material raw material 1 will have a predetermined thickness.

<Conveying Device 10>

The conveying device 10 is a member for conveying the cathode active material raw material 1. As in FIG. 1, the conveying device 10 is provided with a conveying member 11 that conveys the cathode active material raw material 1, and a driving unit (not shown) for driving the conveying member 11.

(Conveying Member 11)

The conveying member 11 is a member that conveys the cathode active material raw material 1 (conveyor). The conveying member 11 is a member in the form of a sheet, and is driven by the driving unit from the upstream side toward the downstream side in the conveying direction. It is necessary for the conveying member 11 to be arranged on the lower surface of the cathode active material raw material 1 because the conveying member 11 conveys the cathode active material raw material 1 as the cathode active material raw material 1 is put thereon. The conveying member 11 may be also arranged on the upper surface of the cathode active material raw material 1 as shown in FIG. 1. In other words, the cathode active material raw material 1 may be conveyed as held between the conveying member 11.

As described later, the manufacturing apparatus 100 is to heat the cathode active material raw material 1 by contact heating. The cathode active material raw material 1 may be therefore heated by direct contact with the heating members 31. This however causes the cathode active material raw material 1 to adhere to the heating members 31, and leads to lower productivity. Then, in the manufacturing apparatus 100, adhering the cathode active material raw material 1 to the heating members 31 is suppressed by bringing the heating members 31 into contact with the cathode active material raw material 1 via the conveying member 11. For such a reason, the cathode active material raw material 1 may be conveyed by, as held between the conveying member 11 when the upper and lower surfaces of the cathode active material raw material 1 are heated.

It is necessary to make the conveying member 11 out of a member resistant to the heating temperature in the heating unit 30 (heat-resistant member) because the conveying member 11 is to be in contact with the heating members 31. For example, it is necessary for the heat-resistant member to be resistant to a temperature of 900° C. or higher. Examples of such a heat-resistant member include quartz cloths and silica fiber cloths.

Here, it is necessary to take in oxygen from the outside in order to progress firing of the cathode active material raw material 1 when a material that becomes an oxide by the oxidation of the metal hydroxide, a lithium hydroxide, or the like is contained in the cathode active material raw material 1. Meanwhile, the cathode active material raw material 1 generates a gas such as moisture (water vapor) and carbon dioxide by firing. Therefore, the cathode active material raw material 1 is preferably fired in an environment where gases can be exchanged. Thus, the conveying member 11 may be made of a porous heat-resistant member that allows gas to be efficiently exchanged with the gas outside. The pore size of the porous heat-resistant member is not particularly limited as long as an efficient gas exchange can be performed through the pores, and as long as the cathode active material raw material 1 does not leak to the outside through the pores. For example, the pore size of the porous heat-resistant member may be at most 20 at most 10 at most 5 at least 3 at least 1 or at least 0.5 The porous heat-resistant member having too large a pore size causes the cathode active material raw material 1 to easily leak to the outside. The porous heat-resistant member having too small a pore size causes the efficiency of the gas exchange with the outside to lower. Examples of such a porous heat-resistant member include fibrous heat-resistant members. Examples of the fibrous heat-resistant member include quartz cloths and silica fiber cloths.

Here, the pore size of the porous heat-resistant member is a diagonal length of a mesh opening obtained by the fiber diameter and the product density (unit: number of fibers/mm).

<Forming Member 20>

The forming member 20 is a member to form the cathode active material raw material 1 into a sheet. As shown in FIG. 1, the forming member 20 is arranged on the upstream side of the heating unit 30 in the conveying direction. In the manufacturing apparatus 100, the forming member 20 is an optional member because the cathode active material raw material 1 may be formed into a sheet in advance as described above.

An example of the forming member 20 is a powder amount controlling member to control the powder amount of the cathode active material raw material 1 to be conveyed, and form the cathode active material raw material 1 into a sheet. Examples of the powder amount controlling member include a powder amount controlling knife shown in FIG. 1, and any member to press and form the cathode active material raw material 1 into a sheet.

The thickness of the cathode active material raw material 1 in the form of a sheet which is formed with the forming member 20 is not particularly limited, but for example, may be at least 0.1 mm, at least 0.5 mm, at least 1 mm, at least 2 mm, at most 50 mm, at most 30 mm, less than 30 mm, at most 20 mm, at most 10 mm, or at most 5 mm.

<Heating Unit 30>

The heating unit 30 is to heat (fire) the cathode active material raw material 1. As shown in FIG. 1, the heating unit 30 is a rectangular housing, and is provided with the six heating rollers 31 (heating members) thereinside.

The cathode active material raw material 1 may be heated in the heating unit 30 at 700° C. or higher, at 800° C. or higher, at 900° C. or higher, at 1100° C. or lower, or at 1000° C. or lower. The skilled person may set the temperature at which the cathode active material raw material 1 can be suitably fired. As described later, the contact of the cathode active material raw material 1 with the heating rollers 31 causes the cathode active material raw material 1 to be heated. Therefore, actually, the heating rollers 31 are each heated to a predetermined temperature. The heating rollers 31 may be each heated to the same or different temperature(s). For example, some of the heating rollers 31 arranged on a more upstream side in the conveying direction may be heated to a lower temperature for the purpose of oxidation, and some of the heating rollers 31 arranged on a more downstream side in the conveying direction may be heated to a higher temperature for the purpose of firing.

The cathode active material raw material 1 may be heated in an oxidizing atmosphere in the heating unit 30 because the oxidation reaction of the cathode active material raw material 1 is promoted. The heating unit 30 is provided with an air blowing part (not shown) in order to make the inside thereof an oxidizing atmosphere. The supply of air or oxygen from the air blowing part to the inside of the heating unit 30 can keep the inside of the heating unit 30 in an oxidizing atmosphere. Air or oxygen may be continuously supplied in order to keep the inside of the heating unit 30 in a negative pressure. For example, a known blower may be used as the air blowing part. When the cathode active material raw material does not contain any material that can lead to an oxidation reaction, it is not necessary to make the inside of the heating unit 30 an oxidizing atmosphere because it is not necessary to oxidize the cathode active material raw material 1 in the heating unit 30.

Here, in this description, “oxidizing atmosphere” is an atmosphere where a target material can be oxidized, and is, for example, an atmosphere of a space that is filled with a gas supplied thereto, and thus containing at least 1% oxygen (e.g., air or oxygen). The oxygen concentration in the space may be suitably set according to the speed at which the oxidation of the target material progresses.

(Heating Rollers 31)

The heating rollers 31 (heating members) are members to heat the cathode active material raw material 1 by heat conduction. “To heat the cathode active material raw material 1 by heat conduction” is what is called contact heating (the cathode active material raw material 1), and means to heat the cathode active material raw material 1 by bringing the heating members into direct or indirect contact with the cathode active material raw material 1. “Indirect” means to heat the cathode active material raw material 1 by bringing the heating members into contact with the cathode active material raw material 1 via any other member(s). In FIG. 1, the cathode active material raw material 1 is heated by bringing the heating rollers 31 into contact therewith via the conveying member 11. The cathode active material raw material 1 may be heated by bringing the heating members into contact therewith via (a) member(s) other than the conveying member 11, or via the conveying member 11 and any other member(s). In this description, “direct or indirect contact” may be simply referred to as “contact” unless otherwise mentioned.

The heating rollers 31 are to heat the cathode active material raw material 1 by contact heating, and their features are that a contacted portion can be efficiently heated, and that the thermal uniformity of the contacted portion is high. Accordingly, the time for firing the cathode active material raw material 1 can be shortened, and variations in crystallinity can be reduced. Conventionally, two heating steps of a calcining step and a firing step are required for manufacturing a cathode active material because contact heating leads to high thermal uniformity. With the manufacturing apparatus 100, the cathode active material can be obtained by firing the cathode active material raw material in one step. Therefore, according to the manufacturing apparatus 100, the productivity of the cathode active material can be improved. A shortened heating time also allows facilities to be smaller.

Employing the heating rollers 31 as the heating members allows the cathode active material raw material 1 to be conveyed and heated at the same time. This enables the cathode active material 2 to be continuously manufactured.

As shown in FIG. 1, the heating unit 30 is provided with the six heating rollers 31. The aspect of the arrangement of, and the number of the heating rollers 31 are not particularly limited. As shown in FIG. 1, the heating rollers to heat one surface (e.g., the upper surface) of the cathode active material raw material 1, and the heating rollers to heat the other surface (e.g., the lower surface) thereof may be alternately arranged from the upstream side to the downstream side in the conveying direction. This allows both the surfaces of the cathode active material raw material 1 to be equally heated. Thus, the temperature irregularity in the cathode active material raw material 1 is suppressed.

Any adjacent two of the heating rollers 31 may be arranged as facing each other so as to hold the cathode active material raw material 1 therebetween. This allows both the surfaces of the cathode active material raw material 1 to be heated at the same time. Thus, heating efficiency can be improved, and temperature irregularity can be suppressed. The arrangement of any adjacent two of the heating rollers 31 as the adjacent two face each other allows the cathode active material raw material 1 to be heated by applying pressure. In other words, the cathode active material raw material 1 can be hot-formed into a sheet. Adjustment of the gaps between the facing heating rollers 31 enables the thickness of the cathode active material raw material 1 in the form of a sheet to be adjusted. For example, the gaps between the facing heating rollers 31 may be each gradually narrowed from the upstream side to the downstream side in the conveying direction. This allows the heating rollers 31 to be arranged so that the heating rollers 31 can surely hold the cathode active material raw material 1 therebetween. Thus, the temperature irregularity in the cathode active material raw material 1 is suppressed. It is not necessary to strictly adjust the gaps between the heating rollers 31 because the purpose of the heating members 31 is not to form the cathode active material raw material 1.

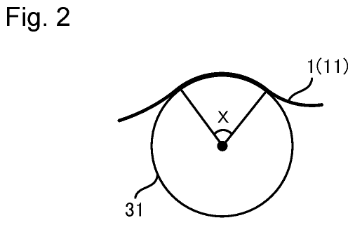

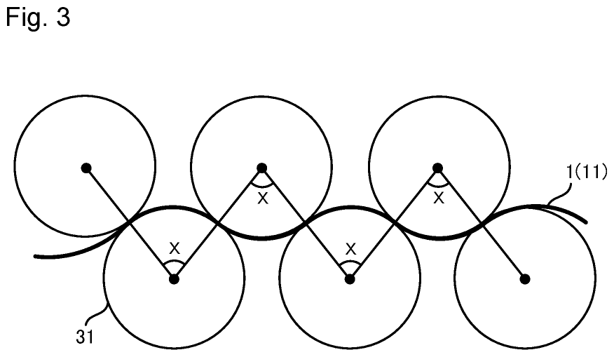

In FIG. 1, any two adjacent heating rollers are arranged so as to face each other. As can be seen from FIG. 1, a wrap angle is set for each of the heating rollers 31 except the heating rollers 31 on the most upstream side and on the most downstream side. FIG. 2 explanatorily shows the wrap angle. FIG. 3 shows an enlarged view of the heating rollers 31 of FIG. 1.

As indicated by “x” in FIGS. 2 and 3, “wrap angle” is a center angle of the heating roller 31 obtained using the range of the heating roller 31 from a point which the cathode active material raw material 1 (conveying member 11) touches, to a point where the cathode active material raw material 1 separates from the heating roller 31. Setting the wrap angle x for the heating roller 31 as in FIG. 2 allows the contact area between the heating roller 31 and the cathode active material raw material 1 to increase, and heating efficiency to be improved. In addition, nonuniform heating is suppressed, and a gas exchange can be promoted because the cathode active material raw material 1 can be drawn and moved. It can be also suppressed for the cathode active material raw material 1 to adhere to the heating rollers 31. While heating both the surfaces of the cathode active material raw material 1, which is held between the heating rollers 31 arranged as facing each other, causes firing of the cathode active material raw material 1 to progress, a contact face of the cathode active material raw material 1 which is not held between the heating rollers 31 but is in contact with the heating rollers 31 on either side is heated, and at the same time a gas exchange can be performed via an open face of the cathode active material raw material 1 which is not in contact with the heating rollers 31. Thus, firing the cathode active material raw material 1 can be promoted. Therefore, the arrangement of the heating rollers 31 as in FIGS. 1 and 3 allows both the surfaces, and either surface of the cathode active material raw material 1 to be alternately heat (to be hot-formed in terms of both the surface). According to this, heating and an efficient gas exchange are alternately performed, and thus firing is promoted.

The wrap angle x of the heating rollers 31 may be at least 10°, at least 20°, at most 180°, or at most 90°. The heating rollers having too narrow a wrap angle make it difficult to draw and move the cathode active material raw material 1. The heating rollers 31 having too wide a wrap angle causes, at places of the heating rollers 31 along the vertical direction or therearound, the cathode active material raw material 1 to drop, or for example, to shift thereby changing the thickness in conveying. This may make temperature control difficult. Disadvantage when the wrap angle is wide is particularly likely to be suffered when the cathode active material raw material 1 and the heating rollers 31 are not always in contact with each other.

Furthermore, in FIG. 3, the heating rollers 31 are arranged so that a straight line connecting the centers of any adjacent two of the heating rollers 31 overlaps one of the straight lines that form the wrap angle of either one of the adjacent two. This allows the cathode active material raw material 1 to be always in contact with the heating rollers 31, heating efficiency to be improved, and the heating time to be shortened.

In FIG. 3, the wrap angle is set for each of the heating rollers 31 except the heating rollers 31 on the most upstream side and on the most downstream side. The wrap angle may be also set for each of the heating rollers 31 on the most upstream side and on the most downstream side.

The material of the heating members 31 is not particularly limited. For example, the heating members 31 may be made from a material that is resistant to a temperature of 1000° C. or higher. Examples of such a material include inorganic materials such as ceramics and metallic materials such as iron.

The rotation direction of the heating rollers may be in normal rotation (rotation in the same direction as the conveying direction), or in reverse rotation (rotation in the direction opposite to the conveying direction). The rotation number of the heating rollers is not particularly limited. The skilled person may suitably select optimum rotation direction and rotation number in and at which both thermal uniformity and economic efficiency are achieved.

The surfaces of the heating rollers 31 may have roughness. The surfaces of the heating rollers 31 in a rough form allow the cathode active material raw material 1 in contact with the heating rollers 31 to be drawn and moved, nonuniform heating to be suppressed, and a gas exchange to be promoted. It can be also suppressed for the cathode active material raw material 1 to adhere to the heating rollers.

The length of the heating rollers 31 in the width direction is not particularly limited. For example, the length of the heating rollers 31 may be set as long as that of the conveying member 11 in the width direction. The diameter of the heating rollers 31 is suitably set in view of the size of the heating unit 30, and suitable heating of the cathode active material raw material 1.

<Recovery Part 40>

The recovery part 40 is a member to recover the cathode active material 2 obtained in the heating unit 30. When the cathode active material 2 is held between and conveyed by the conveying member 11 as in FIG. 1, one may separate the conveying member at the recovery part 40, and recover the cathode active material 2 from the inside of the conveying member. The recovered cathode active material 2 may be crushed. The way of crushing the cathode active material 2 is not particularly limited. The cathode active material 2 may be crushed with, for example, a hammer after the recovery. When the cathode active material raw material 1 is in the form of a sheet, the obtained cathode active material 2 is also in the form of a sheet, and thus can be easily crushed. For example, the cathode active material 2 crushes just as a result of recovery thereof as in FIG. 1.

When a porous heat-resistant member is used for the conveying member 11, the cathode active material 2 is sometimes buried in internal pores. In such a case, the cathode active material 2 buried inside can be recovered by vibrating the conveying member 11 in a condition where the conveying member 11 is turned over, or by blowing air against a surface not in contact with the cathode active material 2 (the arrows in FIG. 1), and thus productivity can be improved. An example of a device with which the vibration is imposed is a vibration knocker. An example of a device with which air is blown is an air blower.

<Cathode Active Material 2>

The cathode active material 2 obtained in the manufacturing apparatus 100 has composition of lithium inserted into the metal oxide. For example, the molar ratio of the metallic elements of the cathode active material 2 may be as follows. Li:Ni:Co:Mn=s:x:y:z (0.8≤s≤1.2, x=1−y−z, 0≤y<1 and 0≤z<1) or Li:Ni:Co:Al=s:x:y:z (0.8≤s≤1.2, x=1−y−z, 0≤y<1 and 0≤z<1). The composition of the cathode active material 2 may be LiₛNiₓCo_{y}Mn_{z}(O)_{2+α} (0.8≤s≤1.2, x=1−y−z, 0≤y<1, 0≤z<1 and −0.5≤α<0.5) or LiₛNiₓCo_{y}Al_{z}(O)_{2+α} (0.8≤s≤1.2, x=1−y−z, 0≤y<1, 0≤z<1 and −0.5≤α<0.5).

Variations in the crystallinity of the obtained cathode active material 2 are reduced because the cathode active material raw material 1 is fired by contact heating. Variations in crystallinity are obtained by crystallite size determination with XRD. The optimum range of the crystallite size (unit: nm) is set in view of the evaluation result of a battery including the cathode active material 2. For example, the range of the crystallite size may be approximately ±200 nm, ±100 nm, or ±50 nm.

### Another Embodiment

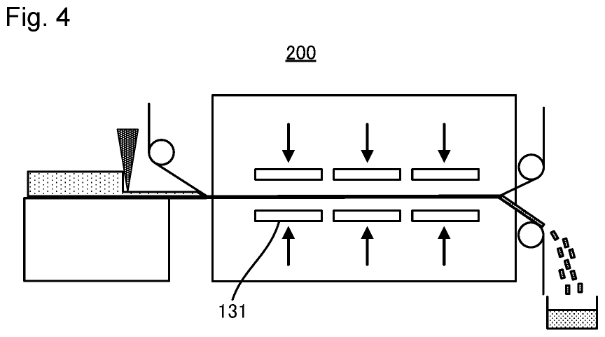

FIG. 4 shows a manufacturing apparatus of a cathode active material for lithium ion secondary batteries 200 (may be referred to as “manufacturing apparatus 200” in this description). In the manufacturing apparatus 200, the heating rollers 31 of the manufacturing apparatus 100 are changed to tabular heating members 131. The material etc. of the tabular heating members 131 are the same as those of the heating rollers 31.

The tabular heating members 131 are tabular heating members. As shown in FIG. 4, three pairs of the tabular heating members 131 are aligned in the conveying direction: each pair is made up of two tabular heating members 131 on the upper and lower sides, respectively. The cathode active material raw material 1 is heated by raising and lowering the tabular heating members 131, and holding the cathode active material raw material 1 between the tabular heating members 131. At this time, the cathode active material raw material 1 may be pressure-molded. In the heating, the conveying member 11 is temporarily stopped. As described above, contact heating can be realized even with the tabular heating members 131 as heating members.

(Supplementary)

In each of the manufacturing apparatuses 100 and 200, a plurality of the heating members are used. The manufacturing apparatus according to the present disclosure is not limited to this. It is sufficient that the manufacturing apparatus according to the present disclosure is provided with at least one heating member because it is sufficient that the heating member(s) of the minimum number necessary for firing the cathode active material raw material 1 is disposed. The heating members are not limited to be in the form of a roll or a plate, but any of various forms may be employed therefor because it is sufficient that the heating members have a shape with which contact heating can be realized.

[Method for Manufacturing Cathode Active Material for Lithium Ion Secondary Batteries]

The method of manufacturing a cathode active material for lithium ion secondary batteries according to the present disclosure will be described with reference to a method of manufacturing a cathode active material for lithium ion secondary batteries 1000 which is one embodiment (may be referred to as “manufacturing method 1000” in this description).

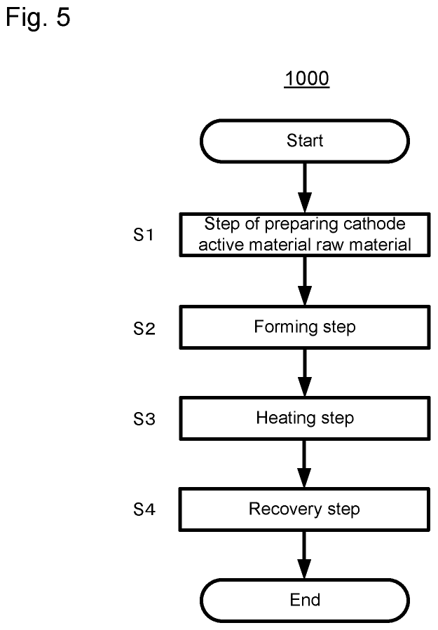

FIG. 5 shows a flowchart of the manufacturing method 1000. As in FIG. 5, the manufacturing method 1000 includes a step S1 of preparing a cathode active material raw material, a forming step S2, a heating step S3 and a recovery step S4. The forming step S2, the heating step S3 and the recovery step S4 can be performed with the manufacturing apparatus according to the present disclosure.

(Step S1 of Preparing Cathode Active Material Raw Material)

The step S1 of preparing a cathode active material raw material is a step of mixing a metallic compound and a lithium compound, and obtaining a cathode active material raw material. Here, the metallic compound, the lithium compound and the cathode active material raw material are as described above, and thus the description thereof is omitted. The mixing way is also as described above, and thus the description thereof is omitted here.

<Forming Step S2>

The forming step S2 is an optional step, and is provided prior to the heating step S3. The forming step S2 is a step of forming the cathode active material raw material into a sheet. The way of forming the cathode active material raw material into a sheet is not particularly limited. For example, any of the above-described forming ways may be employed.

<Heating Step S3>

The heating step S3 is a step of heating (firing) the cathode active material raw material. Specifically, the heating step S3 is a step of heating the cathode active material raw material by heat conduction. The way of heating the cathode active material raw material is as described above, and thus the description thereof is omitted here.

<Recovery Step S4>

The recovery step S4 is a step of recovering the cathode active material obtained in the heating step S3. The way of recovering the cathode active material is not particularly limited. For example, any of the above-described recovering ways may be employed.

### Other Embodiments

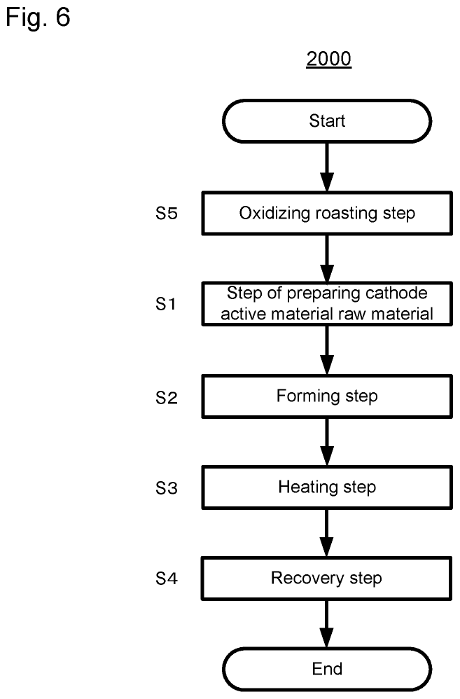

FIG. 6 shows a method of manufacturing a cathode active material for lithium ion secondary batteries 2000 (may be referred to as “manufacturing method 2000” in this description). In the manufacturing method 2000, an oxidizing roasting step S5 is provided in the manufacturing method 1000. The oxidizing roasting step S5 is provided prior to the step S1 of preparing a cathode active material raw material, and is a step of heating a metal hydroxide in an oxidizing atmosphere. The way of subjecting a metal hydroxide to oxidizing roasting is as described above, and thus the description thereof is omitted here. The provision of the oxidizing roasting step S5 enables a metal oxide to be obtained. Oxidation of a metal hydroxide is an endothermic reaction. Thus, the use of a cathode active material raw material containing a metal hydroxide in the heating step S4 may lead to temperature irregularity. Therefore, in the manufacturing method 2000, the oxidizing roasting step S5 is provided, and the oxidation of the metal hydroxide is performed in advance. It is noted that temperature irregularity is suppressed even if the cathode active material raw material containing a metal hydroxide is used because contact heating is employed in the heating step S4.

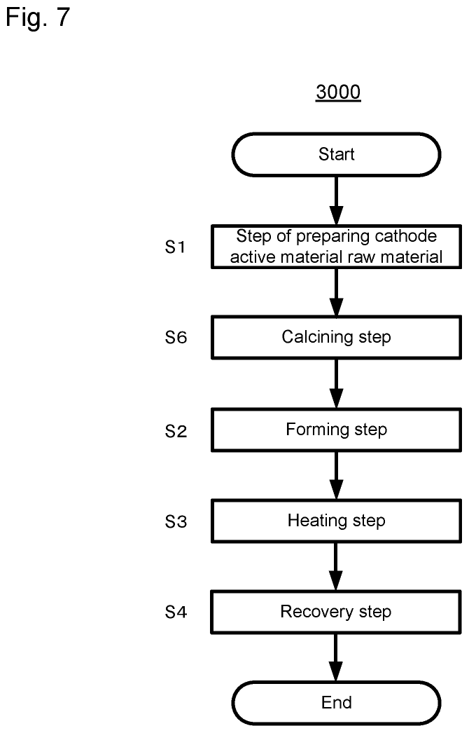

FIG. 7 shows a method of manufacturing a cathode active material for lithium ion secondary batteries 3000 (may be referred to as “manufacturing method 3000” in this description). In the manufacturing method 3000, a calcining step S6 is provided prior to the forming step S2. The calcining step S6 is a step of heating the cathode active material raw material in an oxidizing atmosphere. The calcining step S6 enables a metal hydroxide to be oxidized to a metal oxide, and the lithium compound such as a lithium hydroxide to be oxidized to lithium oxide. Such an oxidation reaction is an endothermic reaction. Thus, completing the oxidation of the cathode active material raw material in the calcining step S6 allows temperature irregularity in the cathode active material raw material in the heating step S4 to be suppressed, and permits short-term firing. It is noted that the cathode active material can be obtained by suitably firing a cathode active material raw material containing, for example, a metal hydroxide even if the calcining step S6 is not provided because contact heating is employed in the heating step S4.

The heating temperature in the calcining step S6 is, for example, 700° C. to 800° C. The heating time is, for example, 0.5 hours to 3 hours. Such heating may be carried out using a firing device such as a rotary kiln.

In the manufacturing method according to the present disclosure, both the oxidizing roasting step S5 and the calcining step S6 may be combined.

The manufacturing apparatus of a cathode active material for lithium-ion secondary batteries, and the method of manufacturing a cathode active material for lithium-ion secondary batteries according to the present disclosure have been each described using the embodiments. In the present disclosure, contact heating in which the cathode active material raw material is heated by heat conduction is employed. The features of contact heating are that a contacted portion can be efficiently heated, and that the temperature irregularity in the contacted portion is slight (the thermal uniformity of the contacted portion is high). Therefore, according to the present disclosure, where contact heating is employed, the time for firing the cathode active material raw material can be shortened, and variations in crystallinity can be reduced. In addition, the cathode active material can be obtained by firing the cathode active material raw material with one heating unit (heating step) according to the present disclosure, which is different from a conventional apparatus or method. Therefore, according to the present disclosure, the productivity of the cathode active material can be improved. A shortened heating time also allows facilities to be smaller.

### INDUSTRIAL APPLICABILITY

The cathode active material manufactured according to this disclosure may be used for a cathode of any of a nonaqueous lithium-ion secondary battery, an aqueous lithium-ion secondary battery, and an all-solid-state lithium-ion secondary battery.

### REFERENCE SIGNS LIST

1 cathode active material raw material
2 cathode active material
10 conveying device
11 conveying member
20 forming member
30 heating unit
31 heating roller (heating member)
40 recovery part
131 tabular heating member (heating member)
100, 200 manufacturing apparatus of a cathode active material for lithium ion secondary batteries

What is claimed is:

1. A manufacturing apparatus of a cathode active material for lithium ion secondary batteries, the apparatus comprising:
a conveying device conveying a cathode active material raw material that contains a metallic compound and a lithium compound, the metallic compound including at least one metallic element selected from the group consisting of nickel, cobalt and manganese; and
a heating unit adapted to heat the cathode active material raw material, wherein
the heating unit has at least one heating member adapted to heat the cathode active material raw material by heat conduction.

2. The manufacturing apparatus according to claim 1, wherein the heating member is a heating roller.

3. The manufacturing apparatus according to claim 1, wherein
the heating members are plural heating rollers,
some of the heating rollers adapted to heat one surface of the cathode active material raw material, and a rest of the heating rollers adapted to heat another surface of the cathode active material raw material are alternately arranged from an upstream side to a downstream side in a conveying direction, and
any adjacent two of the heating rollers are arranged as facing each other so as to hold the cathode active material raw material therebetween.

4. The manufacturing apparatus according to claim 2, wherein a wrap angle of the heating roller is 10° to 180°.

5. The manufacturing apparatus according to claim 1, wherein in the heating unit, the cathode active material raw material is heated to 700° C. to 1000° C.

6. The manufacturing apparatus according to claim 1, wherein in the heating unit, the cathode active material raw material is heated in an oxidizing atmosphere.

7. The manufacturing apparatus according to claim 1, wherein
the conveying device has a conveying member made of a porous heat-resistant member, and
the cathode active material raw material is heated with the heating member via the porous heat-resistant member.

8. The manufacturing apparatus according to claim 1, further comprising:
a forming member adapted to form the cathode active material raw material into a sheet, the forming member being on the upstream side of the heating unit in the conveying direction.

9. The manufacturing apparatus according to claim 1, further comprising:
a recovery part adapted to recover a cathode active material obtained in the heating unit.

10. A method of manufacturing a cathode active material for lithium ion secondary batteries, the method comprising:
preparing a cathode active material raw material by mixing a metallic compound and a lithium compound, the metallic compound including at least one metallic element selected from the group consisting of nickel, cobalt and manganese, and obtaining the cathode active material raw material; and
heating the cathode active material raw material, wherein
in the heating, the cathode active material raw material is heated by heat conduction.

11. The method according to claim 10, wherein in the heating, the cathode active material raw material is conveyed and heated at the same time.

12. The method according to claim 10, wherein
in the heating, both surfaces of the cathode active material raw material, and either surface of the cathode active material raw material are alternately heated.

13. The method according to claim 11, wherein in the heating, the cathode active material raw material is heated using a heating roller having a wrap angle of 10° to 180°.

14. The method according to claim 10, wherein in the heating, the cathode active material raw material is heated to 700° C. to 1000° C.

15. The method according to claim 10, wherein in the heating, the cathode active material raw material is heated in an oxidizing atmosphere.

16. The method according to claim 10, wherein in the heating, the cathode active material raw material is heated via a porous heat-resistant member.

17. The method according to claim 10, further comprising:
forming the cathode active material raw material into a sheet, prior to the heating.

18. The method according to claim 10, further comprising:
recovering a cathode active material obtained in the heating.
